(19) United States
(12) Patent Application Publication
(10) Pub. No.: US 2010/0180427 A1
(43) Pub. Date: Jul. 22, 2010

(54) TEXTURING OF THIN METAL SHEETS/FOILS FOR ENHANCED FORMABILITY AND MANUFACTURABILITY

(75) Inventor: Huimin Liu, Northville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 12/355,394

(22) Filed: Jan. 16, 2009

(51) Int. Cl. B21B 1/46; B21D 13/00; H01M 2/02

(52) U.S. Cl. 29/527.2; 428/603; 429/452

(57) ABSTRACT

According to at least one aspect of the present invention, a method is provided for enhancing formability and manufacturability of a thin metal sheet/foil. In at least one embodiment, the method includes texturing a thin metal sheet/foil to accumulate additional metal materials in the areas to be formed, and providing a textured thin metal sheet/foil with a wavy topography of various peak-to-valley amplitudes and peak-to-peak wave lengths, depending on part design complexity and forming difficulties.

### BACKGROUND

1. Technical Field

Embodiments of the present invention relate to texturing of thin metal sheets/foils and its applications for enhanced formability and manufacturability.

2. Background Art

In an effort to improve fuel efficiency and reduce environmental pollution, automotive Original Equipment Manufacturers (OEMs) have made tremendous investment in developing hybrid vehicles while applying an increasing amount of advanced materials for light weight Body-In-White (BIW). In the past decade, Hybrid Electrical Vehicles (HEVs) with Nickel-Metal Hydride and recently Lithium-Ion batteries became a commercial reality. Contemporarily, a small number of Fuel Cell Vehicles (FCVs) have also been manufactured for fleet evaluation.

Among the various fuel cell systems evolved, Proton Exchange Membrane Fuel Cell (PEMFC) has been extensively used in automotive vehicles due to its cost effectiveness, packaging flexibility and operating conditions more suitable to automotive applications, among others.

A key component in PEMFC is Bi-Polar Plate (BPP). In early generations of PEMFC, grafoils and carbon-composites were the primary materials for BPPs. During the recent development of PEMFC, metallic materials have been increasingly used for Metal Bi-Polar Plates (MBPPs) owing to their cost advantage, manufacturing efficiency, weight saving, non-permeability and superior strength, stiffness and durability at equivalent or superior electrical and electrochemical properties.

While metals present many advantages, metals may be susceptible to limited formability as compared to the forming difficulties derived from the continuously increasing plate design/performance requirements. It remains desirable to provide thin metal sheets/foils having improved formability and manufacturability and hence enhanced adaptability for use in fuel cell applications, in particular, automotive PEMFC stack applications.

### SUMMARY

According to at least one aspect of the present invention, a method is provided for enhancing formability and manufacturability of a thin metal sheet/foil. In at least one embodiment, the method includes texturing a thin metal sheet/foil to accumulate additional metal materials in the areas to be formed for enhanced formability and manufacturability thereof, and providing a textured thin metal sheet/foil with a topography of engineered patterns, wherein the engineered patterns may be of wavy shapes.

In at least another embodiment, the wavy shapes may propagate in two different directions, wherein the waves of short wave-lengths resembling the channel contour of the metal plate to be formed propagate perpendicularly to the channel-length direction, while superimposing the waves of longer wave-lengths which propagate in the channel-length direction.

In at least yet another embodiment, for relatively simple plate designs with primarily straight channels of moderate forming difficulties in the active area, at a channel-depth to sheet-metal-thickness ratio of 3 or less, the waves are provided with a ratio of peak-to-valley-amplitude to sheet-metal-thickness ranging from 0.1 to 0.4.

In at least yet another embodiment, for relatively complex plate designs with multiple curvatures and of moderate to high forming difficulties, at a channel-depth to sheet-metal-thickness ratio of 3 to 4, short waves or smoothly connected, round-shaped ‘hills’ and ‘valleys’ are provided with a ratio of peak-to-valley-amplitude to sheet-metal-thickness in the range of 0.4 to 1.0.

In at least yet another embodiment, for relatively simple plate designs with primarily straight channels of very high forming difficulties, at a channel-depth to sheet-metal-thickness ratio of 4 or more, the waves are provided with a ratio of peak-to-valley-amplitude to sheet-metal-thickness in the range of 1.0 to 4.0.

In at least yet another embodiment, for complex plate designs with multiple curvatures and of very high forming difficulties, the waves are provided to resemble the channel and feature contours of the metal plate to be formed, wherein the texturing process may have to be carried out at a lower speed than that at a metal mill, using a method similar to a progressive die process.

In at least yet another embodiment, the waves are provided with the short wave-lengths (in the direction perpendicular to the channel-length direction) equal to or substantially close to the channel pitches that they resemble, while the longer wave-lengths (in the channel-length direction) depend on the feature contour in the transition and port areas of the metal plate to be formed.

In at least yet another embodiment, the texturing may be carried out at a metal mill during the final rolling stage for high-speed processing.

According to at least another aspect of the present invention, a textured thin metal sheet/foil is provided for forming a metal shape, such as a metal plate in a fuel cell. In at least one embodiment, the metal plate is made of a textured thin metal sheet/foil with a wavy topography of various peak-to-valley amplitudes and peak-to-peak wave lengths, depending on plate design complexity and forming difficulties.

According to at least yet another aspect of the present invention, metal plates formed from the textured thin metal sheets/foils are joined into metal bi-polar plates and provided for use in a fuel cell stack. In at least one embodiment, the texturing improves not only the formability of a given sheet metal/foil toward given design/performance requirements, but also weldability or manufacturability, in general, of the formed metal plates.

### BRIEF DESCRIPTION OF THE DRAWINGS

FIG. 1A depicts a schematic view of an exemplary single PEMFC with formed metal plates;

FIG. 1B depicts a schematic view of an exemplary PEMFC stack with formed and joined metal bi-polar plates;

FIG. 2A illustrates a top view of an exemplary metal plate formed from a thin metal sheet/foil;

FIG. 2B depicts a cross-sectional view of a typical metal plate formed from a thin metal sheet/foil;

FIG. 2C depicts a cross-sectional view of a typical metal bi-polar plate formed from a thin metal sheet/foil and then joined;

FIG. 3 depicts a cross-sectional view of an exemplary texture of wavy shapes along with definition of wave parameters;

FIG. 4 shows three-dimensional views of an exemplary topography on a textured thin metal sheet/foil; Top: Low magnification; Bottom: High magnification;

FIG. 5 depicts a cross-sectional view of an exemplary topography on a textured thin metal sheet/foil in relation to FIG. 4 for moderate forming difficulties;

FIG. 6 depicts a cross-sectional view of an exemplary topography on a textured thin metal sheet/foil for moderate to high forming difficulties;

FIG. 7 depicts a cross-sectional view of an exemplary topography on a textured thin metal sheet/foil for very high forming difficulties; and

FIG. 8 shows a cross-sectional view and surface morphology of flow channels of an exemplary metal plate.

### DETAILED DESCRIPTION OF EMBODIMENTS OF THE INVENTION

Reference will now be made in detail to the compositions, embodiments, and methods of the present invention known to the inventor. However, it should be noted that the disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of materials, conditions and/or uses are to be understood as modified by the word “about” in describing the broadest scope of the present invention. Practice within the numerical limits stated is generally preferred.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

As a key component in Proton Exchange Membrane Fuel Cells (PEMFCs), Bi-Polar Plates (BPPs) have evolved substantially from their earlier generations made of materials such as grafoils and carbon-composites. In recent years, metallic materials have been increasingly used for Metal Bi-Polar Plates (MBPPs) owing to their cost advantage, manufacturing efficiency, weight saving, non-permeability and superior strength, stiffness and durability at equivalent or superior electrical and electrochemical properties. To date, titanium-, nickel-, aluminum-alloys, and stainless steels have been evaluated and/or used for prototype or low-volume MBPPs with various degrees of success. Most recently, forming of thin metal sheets/foils has found intensive applications in MBPP manufacturing, replacing the expensive and low-throughput manufacturing processes used in earlier MBPP generations such as machining and photoetching. In addition to the cost- and manufacturing-effectiveness, another notable advantage of metal forming is its capability of making thinner plates, resulting in more compact stacks desirable for applications in automotive vehicle propulsion systems.

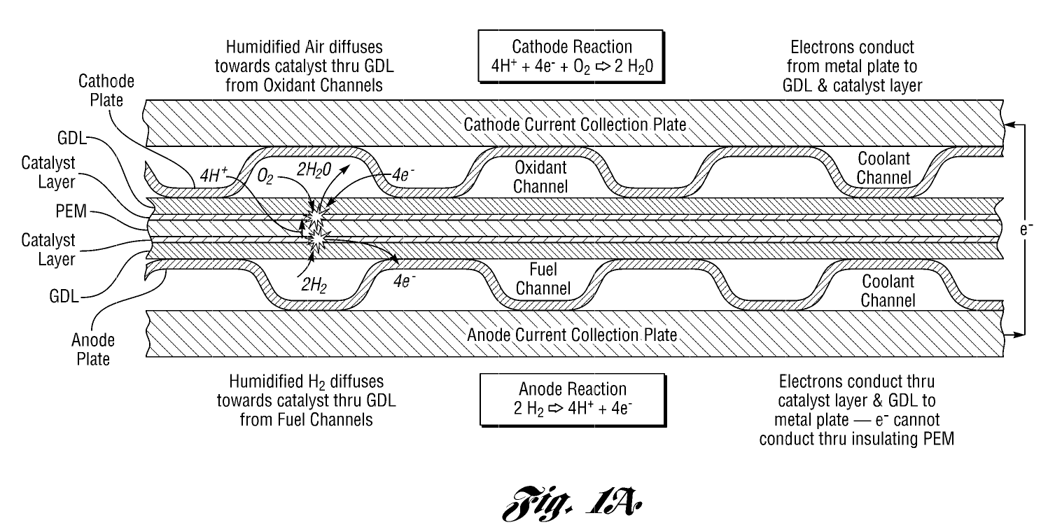

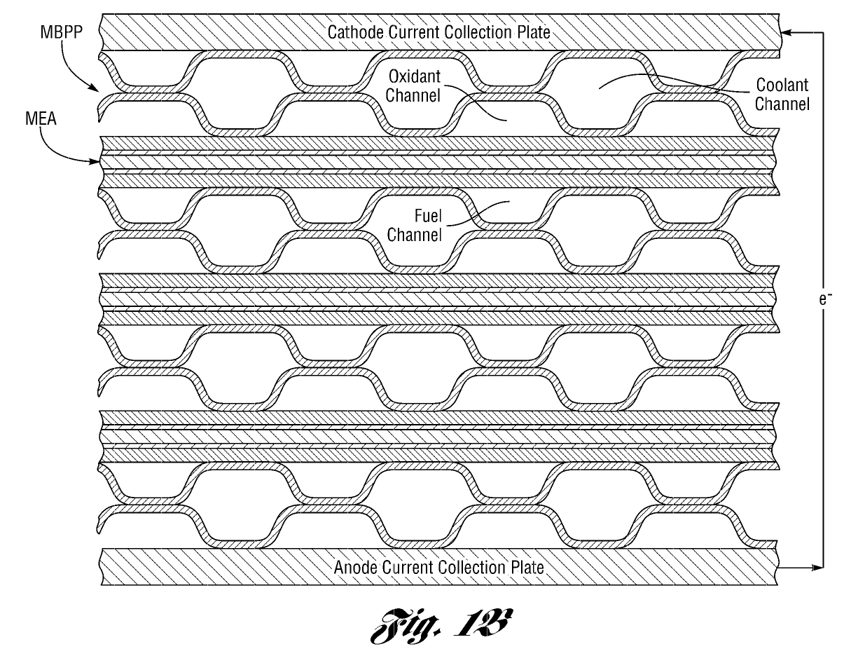

FIGS. 1A and 1B depict schematic views of an exemplary single PEMFC with formed metal plates and an exemplary PEMFC stack with formed and joined MBPPs, respectively, wherein the definition of various components in a PEMFC and stack as well as their functions are described.

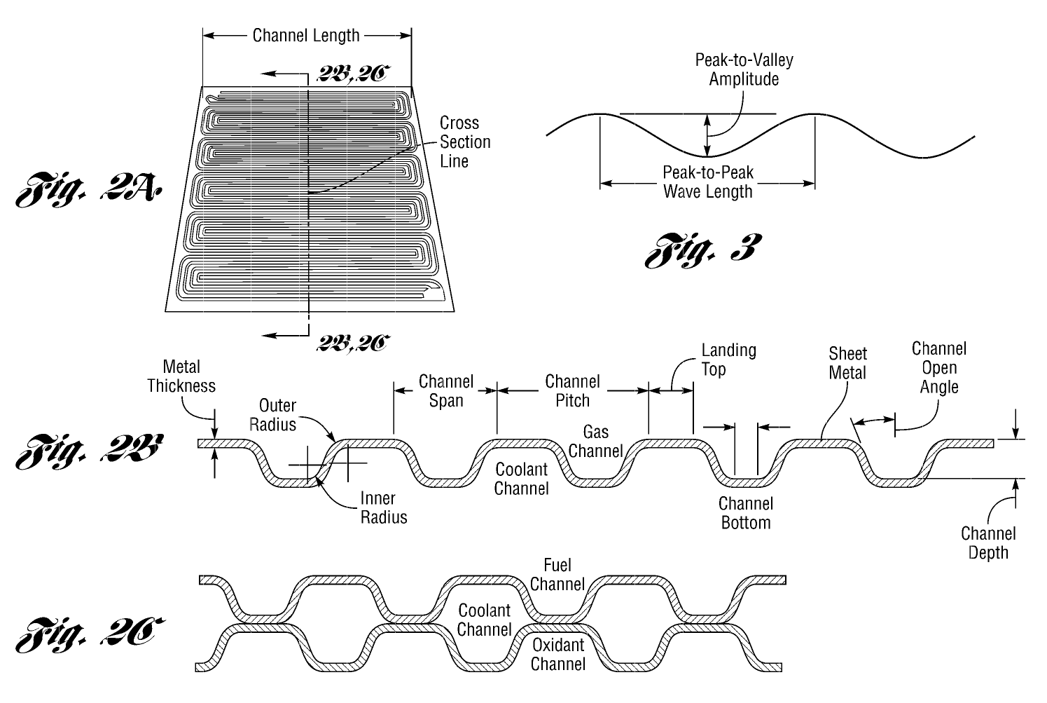

FIG. 2A illustrates a top view of an exemplary metal plate formed from a thin metal sheet/foil. FIG. 2B depicts a cross-sectional view of a typical metal plate formed from a thin metal sheet/foil, wherein the definition of all geometrical parameters is given. FIG. 2C depicts a cross-sectional view of a typical metal bi-polar plate formed from a thin metal sheet/foil and then joined, wherein the definition of various flow channels is shown.

As illustrated in FIG. 2A, geometrical parameters of a metal plate include:

(1) Channel Span,

(2) Channel Depth,

(3) Channel Open Angle,

(4) Channel Inner Radius,

(5) Channel Bottom Width, and

(6) Channel Pitch.

Among the geometrical parameters, channel span exhibits the most significant effect on fuel cell performance. Any increase in channel span results in a decrease in cell performance, attributable to the resultant increase in electrical resistivity and intrusion of Gas Diffusion Layers (GDLs) in gas flow channels. If the channel span would be set as a design constraint, other geometrical parameters would be restricted due to the limits in formability and manufacturability of the currently available metal plate materials and manufacturing systems, limiting channel hydraulic diameter and thus requiring an increase in channel length and/or number of channels for a given active area and pressure drop. This in turn causes significant restrictions on cell design (notably plate length and/or width), and consequently on available stack packaging options.

According to embodiments of the present invention, the term “formability” refers to the capability of a sheet metal to be shaped or formed by plastic deformation and hence is primarily a measure of sheet metal material properties.

According to embodiments of the present invention, the term “forming difficulties” refers to the degree of difficulties to form a shape specified by design/performance requirements without fracture and thus is solely defined by design requirements that are derived from performance requirements. For example, the formability of a sheet metal is determined predominantly by its material properties such as yield and ultimate tensile strengths, total elongation, n-value and R-value, whereas the forming difficulties are defined by design characteristics (that is, channel geometry and overall layout for a metal plate) to meet performance requirements for a given sheet metal, tool/die design and tribology conditions.

According to embodiments of the present invention, the term “manufacturability” refers to the degree of ease to manufacture a product, for example, joining metal plates into bi-polar plates, stacking bi-polar plates into a fuel cell stack, and assembling fuel cell stacks into a fuel cell module.

It has been found, according to the embodiments of the present invention, that lack of metal flow during forming of a thin metal sheet/foil into a metal plate is a key factor causing the limited formability and thus design limitations, notably in the channel depth and channel span, for a given thin metal sheet/foil.

In forming of thin metal sheets/foils for metal plates, very high forming forces or pressures are required due to the high strengths and/or springback of the metals. Unfortunately, the very high forces restrict the metal flow-in from binder areas. In addition, the geometry of typical gas and coolant flow channels is unique, that is, there are many long, narrow, parallel, straight or serpentine gas and coolant flow channels of U-shape in the active area (FIG. 2A) and many straight or curved, continuous or discontinuous U-channels with various cross-sections in the transition and port areas. The unique geometry of the typical gas and coolant flow channels restricts metal draw-in from the landing top and channel bottom to the channel walls (FIG. 2B). Thus, forming of each of the channels causes metal stretching within the channel, predominantly along the walls of the U-channel (see double-arrowed sections in FIG. 8), making the radii highly strained spots (see cross-marked spots in FIG. 8).

FIG. 8 shows a cross-sectional view and surface morphology of flow channels of an exemplary metal plate formed from a thin metal sheet/foil, wherein critical forming spots and areas are depicted along with high magnification surface morphology images as illustrated by the optical micrographs.

Earlier formability analyses and surface characterization results using the techniques invented by the same author showed evidence of high tension strain and significant roughening of channel surface on the outer radii as depicted in the left micrograph of FIG. 8 and high compression strain and remarkable buckling on the inner radii as depicted in the right micrograph of FIG. 8.

As demonstrated in FIG. 8, the lack of metal flow during forming has substantially narrowed the MBPP design window and induced gaps between design/performance requirements and formability/manufacturability. High forming scrap rate has also been observed for certain materials, particularly those with large variations in material properties and/or surface conditions, such as pre-coated sheet metals. These have resulted in high material and manufacturing cost and in-turn increased limitations to automotive applications where light weight and compact fuel cell stacks are required for fuel efficiency and packaging flexibility.

For a selected sheet metal, therefore, any approach which can provide additional metal materials over the areas to be formed will improve formability and manufacturability. As will be discussed in detail hereinafter, the embodiments of the present invention provide a cost-effective and high-efficiency manufacturing method which, by engineered processing, realizes extra metal materials over the areas to be formed and thus addresses the insufficient metal flow issue.

Practicing the method according to the embodiments of the present invention effectuates the imposition of additional metal materials over the areas to be formed, such as the flow channels of the metal plates to be formed from thin metal sheets/foils. In the embodiments of the present invention, imparting additional metal materials is realized via a texturing process.

According to embodiments of the present invention, the term “texture” refers to topography of engineered patterns distributed on a thin metal sheet/foil according to engineering design. The textures used herein may include wavy patterns and/or ‘hills’ and ‘valleys’ that are of engineered shapes and parameters. Accordingly, “texturing” refers to a process to impart certain patterns on a thin metal sheet/foil with dimensions well beyond the standard limitations for flatness and roughness.

By providing extra metal material over the area to be formed, the texturing process according to embodiments of the present invention enables forming of deeper and sharper serpentine U-turns as often desired in PEMFC applications such as automotive vehicle propulsion systems; improves the robustness of forming process by making the process less sensitive to variations in material properties; creates an additional opportunity to improve the formability of pre-coated sheet metals such as clad sheet metals; reduces scrap rate for moderate to severe forming and hence lowers material and manufacturing costs; enlarges part design window; eliminates the gap between fuel cell performance requirements and MBPP manufacturability; and enables lighter weight and more compact fuel cell stacks for better fuel efficiency and more packaging flexibility desirable in automotive vehicle propulsion applications.

The textures imparted onto a thin metal sheet/foil, according to the embodiments of the present invention and will be discussed in detail hereinafter, are not a surface feature conventionally known as surface roughness. Surface roughness alteration as practiced conventionally involves changes less than 0.01 of the sheet-metal-thickness, whereas the textures in the embodiments of the present invention involve changes more than 0.1 of the sheet-metal-thickness in the sheet metal thickness direction. As such, the dimensional changes associated with the textures according to the embodiments of the present invention are at least 10-times greater in amplitude than the conventional alterations in surface roughness.

Surface roughness on sheet metal surfaces is sometimes used for retaining a rust inhibitor and/or forming lubricant, whereas the textures in the embodiments of the present invention are for redistributing metal materials to the areas to be formed in order to improve formability and manufacturability of the sheet metal textured.

Surface roughness increases friction at the metal-tool interface, hinders metal flow, and thus reduces formability. Surface roughness does not redistribute metal materials and therefore cannot be used for gathering extra metal materials in the areas to be formed.

Surface roughness on sheet metal surfaces is of random patterns and randomly distributed, and may occur as a natural and inherent consequence of cold rolling and thus needs no particular external intervention. In contrast, the textures in the present invention are explicitly designed and generated via engineering methods, as described in detail hereinafter.

Surface roughness is rough, whereas the textures in the present invention are smooth per design intent, although microscopic-scale roughness cannot be avoided and normally superimposes the textures. This is due to the inherent surface roughness on the process tools such as rolls used for texturing, which is impressed into the thin metal sheets/foils textured.

Texturing, or creating textures on a thin metal sheet/foil, may be carried out using any suitable processes. For high speed processing, however, texturing should be performed at a metal mill or a metal processor in coil form, where the texturing process may be combined with a cold rolling process for simultaneous gauge reduction.

To impart textures to a thin sheet metal by rolls in a cold rolling process, some engineered/controlled texture patterns are first created onto the rolls by Electrical Beam Texturing (EBT) or Electrical Discharge Texturing (EDT), Laser Texturing, or Selective Coating, or combinations thereof. As the thin metal sheet/foil such as a thin Stainless Steel sheet/foil passes between the rolls, the engineered texture patterns on the rolls are pressed into the thin metal sheet/foil.

For complex textures resulted from complex plate designs with multiple curvatures and of very high forming difficulties, the texturing process may have to be carried out at a lower speed than that at a metal mill, using a method similar to a progressive die process.

According to one aspect of the present invention, a method is provided for enhancing formability and manufacturability of a thin metal sheet/foil. In at least one embodiment, the method includes texturing a thin metal sheet/foil to accumulate additional metal materials in the areas to be formed for enhanced formability and manufacturability thereof, and providing a textured thin metal sheet/foil with a topography of engineered patterns, wherein the engineered patterns may be of wavy shapes.

The texturing according to embodiments of the present invention depends on (1) the sheet metal material properties, (2) the channel geometry and overall layout of the metal plate formed from the sheet metal/foil as per plate design/performance requirements cascaded from fuel cell stack design/performance requirements, (3) the design of forming tools/dies, and (4) the tribology conditions such as lubrication and surface roughness of the forming tools/dies. For a given sheet metal, tool/die design and tribology conditions, the channel geometry and overall plate layout per design/performance requirements define design complexity and forming difficulties.

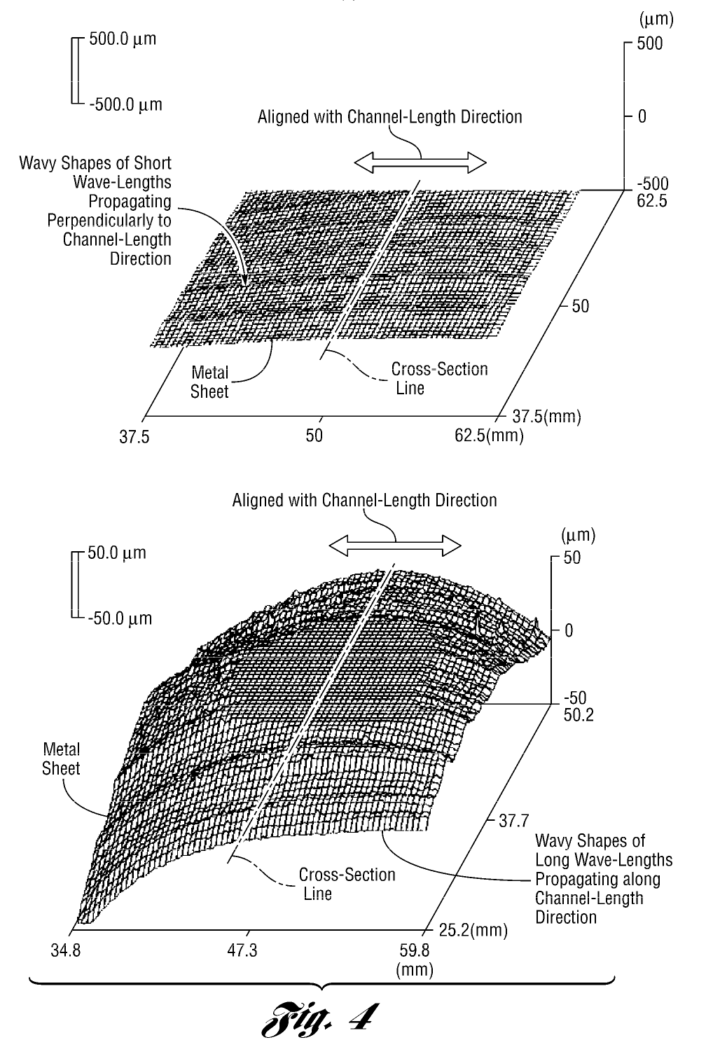

In at least another embodiment, for relatively simple plate designs with primarily straight channels of moderate forming difficulties in the active area, at for example a channel-depth to sheet-metal-thickness ratio of no greater than 3, the texturing creates a topography of engineered patterns on the thin metal sheet/foil, wherein the engineered patterns may be of wavy shapes (FIG. 3) of short wave-lengths resembling the channel contour of the metal plate to be formed and propagating perpendicularly to the channel-length direction, while superimposing the waves of longer wave-lengths which propagate along the channel-length direction (FIG. 4).

FIG. 3 depicts a cross-sectional view of an exemplary texture of wavy shapes along with definition of wave parameters. In this and the following figures on textures, the sheet metal thickness is not shown for simplicity. Therefore, the curves in any two-dimensional (2D) plots or the planes in any three-dimensional (3D) plots should be considered to have a thickness of any applicable metal sheet/foil.

FIG. 4 shows 3D views of an exemplary topography on a textured thin metal sheet/foil for moderate forming difficulties, at a low magnification (Top) and a high magnification (Bottom), respectively, wherein the channel-length direction that the sheet metal texture should be aligned to and the waves of different wave lengths are depicted. These 3D plots were generated by scanning the textured thin metal sheet/foil using a 3D Laser Scanner and associated data acquisition and processing software. The high magnification 3D view is somewhat truncated due to the magnification limit applied. Nevertheless, the 3D view still shows adequate information on the texture of the thin metal sheet/foil according to the embodiment of the present invention.

In addition, the high magnification 3D plot also shows some random surface roughness which is not a feature per the texturing design intent but a natural and inherent consequence of cold rolling due to the surface roughness on the rolls used. Ideally or per engineering design intent, the waves, i.e., texture patterns, should be smooth for the best effect on improving formability and manufacturability.

Moreover, in this and the following figures on textures, the coordinates (referred to as x, y, z hereinafter) in all three (3) dimensions (2 horizontal: x, y, and 1 vertical: z) are exemplary and should be used only for extracting relative dimensions, that is, the peak-to-valley amplitude and peak-to-peak wave length. In particular, because the plots represent only a small portions scanned from a large area of a thin metal sheet/foil, where the origin of the horizontal coordinates (x, y) is normally set by the 3D Laser Scanner at one corner point of the scanning stage while the origin of the vertical coordinate (z) at the Scanner-pre-determined zero level, the absolute values of these coordinates in the plots should not be considered being representing any designed dimensions. Again, only relative dimensions should be extracted for each exemplary scenario.

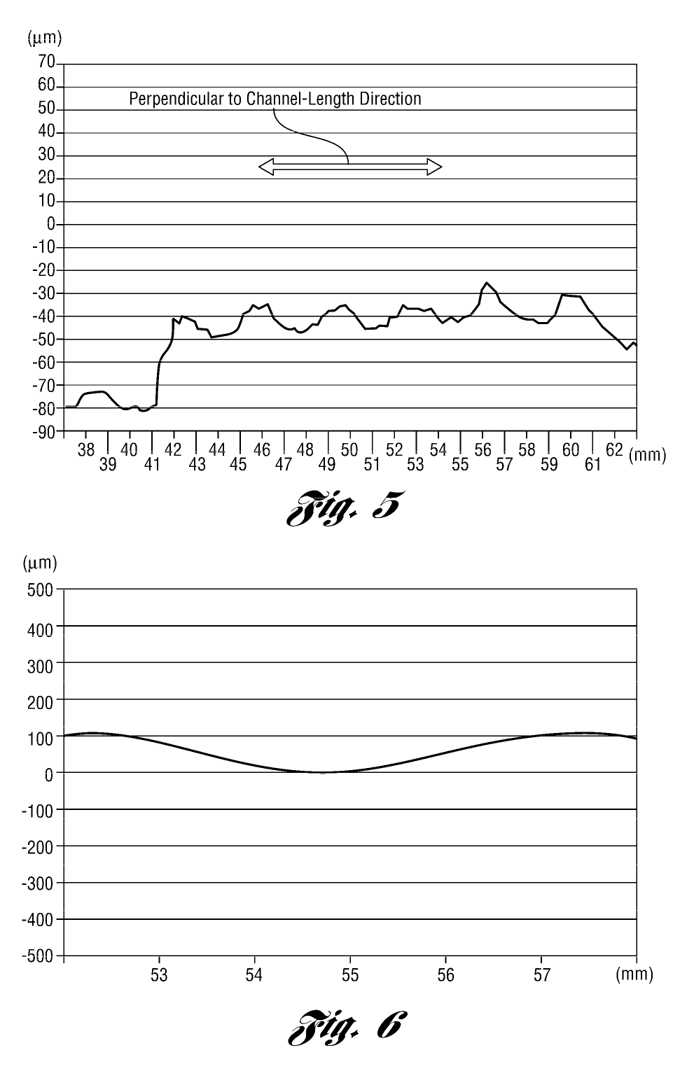

In at least yet another embodiment, for relatively simple plate designs with primarily straight channels of moderate forming difficulties in the active area, at for example a channel-depth to sheet-metal-thickness ratio of 3 or less, the engineered patterns of the wavy shapes may exhibit a peak-to-valley amplitude ranging from 0.1 to 0.4 of the sheet-metal-thickness (FIG. 5), wherein the shorter wave lengths in the direction perpendicular to the channel-length direction are similar to the channel contour in the active area of the metal plate to be formed, that is, the shorter wave lengths should be equal to or sufficiently close to the channel pitches that they resemble, while the longer wave lengths in the channel-length direction depend on the feature contour in the transition and port areas of the metal plate.

FIG. 5 depicts a cross-sectional view of an exemplary topography on a textured thin metal sheet/foil in relation to FIG. 4 for moderate forming difficulties. It should be noted that the Laser-scanned cross-sectional profile shows some random surface roughness which is not designed in but a natural and inherent consequence of cold rolling due to the surface roughness on the rolls used. Ideally or per engineering design, the waves, i.e., texture patterns, should be smooth for the best effect on improving formability and manufacturability.

In at least yet another embodiment, for relatively complex plate designs with multiple curvatures and of moderate to high forming difficulties, at for example a channel-depth to sheet-metal-thickness ratio of 3 to 4, the texturing creates a topography of engineered patterns on the thin metal sheet/foil, wherein the engineered patterns may be of short wavy shapes or smoothly connected, round-shaped ‘hills’ and ‘valleys’ uniformly distributed in both channel length and width (i.e., perpendicular-to-channel-length) directions.

In at least yet another embodiment, for relatively complex plate designs with multiple curvatures and of moderate to high forming difficulties, at for example a channel-depth to sheet-metal-thickness ratio of 3 to 4, the engineered patterns of the short wavy shapes or the smoothly connected, round-shaped ‘hills’ and ‘valleys’ may exhibit a peak-to-valley amplitude in the range of 0.4 to 1.0 of sheet-metal-thickness (FIG. 6), wherein the wave lengths are similar to the channel and feature contours of the metal plate to be formed, that is, the wave lengths should be equal to or sufficiently close to the channel pitches that they resemble.

FIG. 6 depicts a cross-sectional view of an exemplary topography on a textured thin metal sheet/foil for moderate to high forming difficulties.

In at least yet another embodiment, for relatively simple plate designs with primarily straight channels of very high forming difficulties, at for example a channel-depth to sheet-metal-thickness ratio of no less than 4, the texturing creates a topography of engineered patterns on the thin metal sheet/foil, wherein the engineered patterns may be of wavy shapes of shorter wave-lengths resembling the channel contour of the metal plate to be formed and propagating perpendicularly to the channel-length direction, while superimposing the waves of longer wave-lengths which propagate along the channel-length direction.

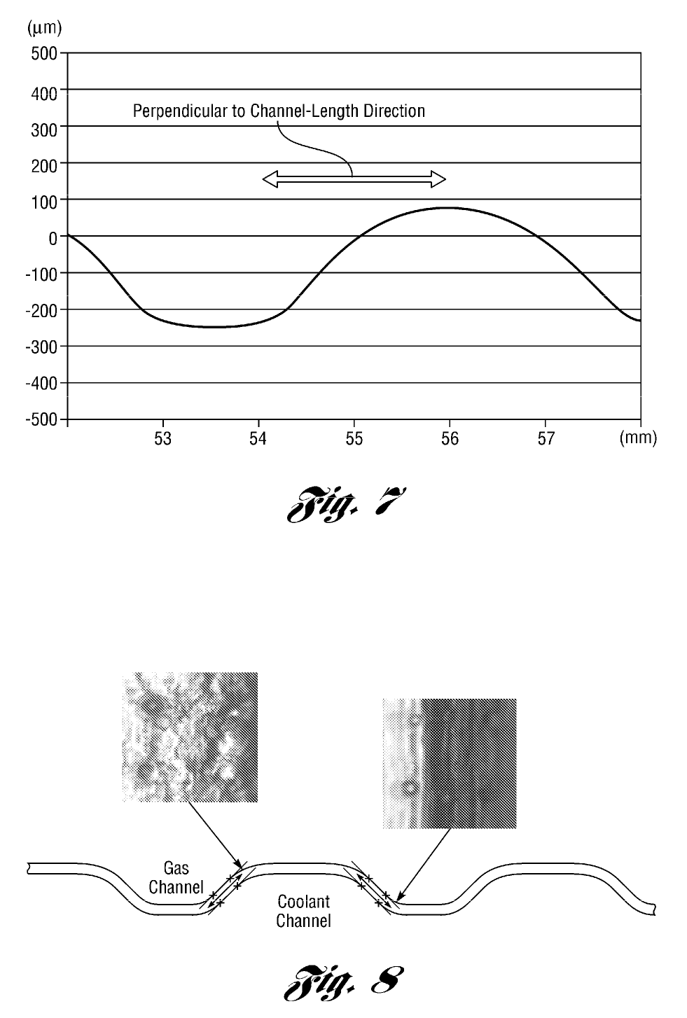

In at least yet another embodiment, for relatively simple plate designs with primarily straight channels of very high forming difficulties, at for example a channel-depth to sheet-metal-thickness ratio of 4 or more, the engineered patterns of the wavy shapes may exhibit a peak-to-valley amplitude ranging from 1.0 to 4.0 of the sheet-metal-thickness (FIG. 7), wherein the shorter wave lengths in the direction perpendicular to the channel-length direction are similar to the channel contour in the active area of the metal plate to be formed, that is, the shorter wave lengths should be equal to or sufficiently close to the channel pitches that they resemble, while the longer wave lengths in the channel-length direction depend on the feature contour in the transition and port areas of the metal plate.

FIG. 7 depicts a cross-sectional view of an exemplary topography on a textured thin metal sheet/foil for very high forming difficulties.

In at least yet another embodiment, the texturing in relation to the above embodiments may be conducted at a metal mill during the final rolling finish stage for high-speed processing. The desired texture patterns are first generated onto the rolls by EBT or EDT, Laser Texturing, or Selective Coating, or combinations thereof. During the rolling, as the thin metal sheet/foil such as a thin Stainless Steel sheet/foil passes between the rolls, the engineered patterns on the rolls are impressed into the thin metal sheet/foil.

In at least yet another embodiment, for complex plate designs with multiple curvatures and of very high forming difficulties, at for example a channel-depth to sheet-metal-thickness ratio of 4 or more, the texturing concept is still valid, that is, the engineered patterns should resemble the channel and feature contours of the metal plate to be formed, however, the texturing process may have to be carried out at a lower speed than that at a metal mill, using a method similar to a progressive die process.

According to at least another aspect of the present invention, a textured thin metal sheet/foil is provided for forming metal plates of a fuel cell. After being textured according to the embodiments of the present invention, the textured thin metal sheets/foils are specially suited to be formed into metal plates adapted for use in a fuel cell application. In at least one embodiment, the metal plates formed from the textured thin metal sheets/foils are provided for use in a fuel cell, in particular, a PEMFC.

In certain particular instances, the metal plates are made of the textured thin metal sheets/foils with a wavy topography of engineered patterns of various peak-to-valley amplitudes and peak-to-peak wave lengths, depending on the plate design complexity and forming difficulties, among other factors detailed above.

According to yet another aspect of the present invention, the metal plates formed from the textured thin metal sheets/foils are joined into MBPPs and provided for use in fuel cell stacks, in particular, PEMFC stacks for fuel cell modules in automotive vehicle propulsion systems.

According to embodiments of the present invention, the texturing improves not only the formability of a given sheet metal/foil toward given design/performance requirements, but also weldability or manufacturability in general of the formed metal plates.

### EXAMPLES

It has been demonstrated that the thin metal sheets/foils textured according to the embodiments of the present invention exhibit enhanced shape formability and manufacturability. The texturing process invented herein creates an additional approach to improve the formability of thin metal sheets/foils and offers more manufacturing flexibility to metal forming plants or shops.

Moreover, the present discovery of imparting extra metal materials by the texturing process is particularly advantageous for forming metal plates used in fuel cells, wherein designing and forming the metal plates suitable for use in fuel cells have their own peculiar limitations as detailed above, and at least one of the limitations is overcome by the present invention.

Consistent formability improvements in forming metal plates of different geometries and design complexities using different forming techniques and presses at different plants/shops have been achieved by means of texturing thin metal sheets/foils according to the embodiments of the present invention. As shown in Table 1 below, 5-7 percent (%) scrap rate reduction has been obtained by texturing the metal sheets before forming the metal plates. In the forming process, Anode plates were formed first so the relatively higher scrap rate of the Anode plates may include the effects of tool/die set up and process parameter tuning. Nevertheless, the data shows evidently remarkable improvements in formability. As a result of the consistent metal plate dimensions formed, an improvement in manufacturability has also been attained.

TABLE 1
effects of texturing on formability
improvement and scrap rate reduction.

| Sheet Metal | Metal Plate | Scrap Rate |
|---|---|---|
| Without Texture | Anode | 10% |
| | Cathode | 5% |
| With Texture | Anode | 3% |
| | Cathode | 0% |

While the best mode for carrying out the invention has been described in detail, those familiar with the art to which this invention relates will recognize various alternative designs and embodiments for practicing the invention as defined by the following claims.

What is claimed:

1. A method for enhancing formability and manufacturability of a thin metal sheet/foil, the method comprising:
texturing a thin metal sheet/foil to accumulate additional metal materials in the areas to be formed for enhanced formability and manufacturability thereof; and
providing a textured thin metal sheet/foil with a topography of engineered patterns, wherein the engineered patterns may be of wavy shapes.

2. The method of claim 1, wherein the wavy shapes may propagate in two different directions: the waves of short wave-lengths resembling the channel contour of the metal plate to be formed propagate perpendicularly to the channel-length direction, while superimposing the waves of longer wave-lengths which propagate in the channel-length direction.

3. The method of claim 2, wherein for relatively simple plate designs with primarily straight channels of moderate forming difficulties in the active area, at a channel-depth to sheet-metal-thickness ratio of 3 or less, the wavy shapes are provided with a ratio of peak-to-valley-amplitude to sheet-metal-thickness ranging from 0.1 to 0.4.

4. The method of claim 2, wherein for relatively complex plate designs with multiple curvatures and of moderate to high forming difficulties, at a channel-depth to sheet-metal-thickness ratio of 3 to 4, short waves or smoothly connected, round-shaped ‘hills’ and ‘valleys’ are provided with a ratio of peak-to-valley-amplitude to sheet-metal-thickness in the range of 0.4 to 1.0.

5. The method of claim 2, wherein for relatively simple plate designs with primarily straight channels of very high forming difficulties, at a channel-depth to sheet-metal-thickness ratio of 4 or more, the wavy shapes are provided with a ratio of peak-to-valley-amplitude to sheet-metal-thickness in the range of 1.0 to 4.0.

6. The method of claim 2, wherein for complex plate designs with multiple curvatures and of very high forming difficulties, the wavy shapes are provided to resemble the channel and feature contours of the metal plate to be formed, while the texturing process may have to be carried out at a lower speed than that at a metal mill, using a method similar to a progressive die process.

7. The method of claim 2, wherein the wavy shapes are provided with the short wave-lengths (in the direction perpendicular to the channel-length direction) equal to or substantially close to the channel pitches in the active area of the metal plate to be formed.

8. The method of claim 2, wherein the wavy shapes are provided with the longer wave-lengths (in the channel-length direction) which depend on the feature contour in the transition and port areas of the metal plate to be formed.

9. The method of claim 2, wherein the texturing may be carried out at a metal mill during the final rolling stage for high-speed processing.

10. Textured thin metal sheet/foils for forming metal shapes, such as metal plates in fuel cells, wherein the textured thin metal sheet/foils are provided with a wavy topography of various peak-to-valley amplitudes and peak-to-peak wave lengths, depending on plate design complexity and forming difficulties, as detailed in the above claims.

11. Metal plates formed from the textured thin metal sheets/foils and joined into metal bi-polar plates for use in a fuel cell stack.
